(19) United States
(12) Patent Application Publication
(10) Pub. No.: US 2024/0424804 A1
(43) Pub. Date: Dec. 26, 2024

(54) PRINTING APPARATUS

(71) Applicant: CANON KABUSHIKI KAISHA, Tokyo (JP)

(72) Inventors: KICHINOSUKE HIROKAWA, Tokyo (JP); TAKUYA HANE, Kanagawa (JP); MASAHARU UEDA, Kanagawa (JP); TAKAYA SATO, Tokyo (JP); YUTO NITAMI, Kanagawa (JP)

(21) Appl. No.: 18/742,257

(22) Filed: Jun. 13, 2024

(30) Foreign Application Priority Data
Jun. 20, 2023 (JP) 2023-100637

(51) Int. Cl. B41J 2/175; B41J 2/19; B41J 25/00

(52) U.S. Cl. CPC B41J 2/17596; B41J 2/19; B41J 25/001; B41J 2202/12

(57) ABSTRACT

A printing apparatus has a circulation unit including a first liquid moving unit configured to supply liquid to a printhead and a second liquid moving unit configured to discharge the liquid circulated inside the printhead and not ejected from an ejection port to an outside of the printhead; a head unit including the printhead and a holding unit configured to hold the printhead; and a head moving unit configured to move the head unit in a first direction. The circulation unit overlaps with a projection plane of the head unit and is not moved by the head moving unit.

### BACKGROUND OF THE INVENTION

### Field of the Invention

The present disclosure relates to a printing apparatus.

### Description of the Related Art

Some inkjet printing apparatuses that perform printing by ejecting liquid from a printhead (hereinafter also referred to simply as a printing apparatus) have a configuration for circulating ink supplied to the printhead. Also, some printing apparatuses are known to include a plurality of printheads. Such a printing apparatus needs to have a plurality of ink circulation paths, which complicates the flow channels inside the apparatus and consequently increases the width of the apparatus.

Japanese Patent Laid-Open No. 2017-193081 (hereinafter referred to as Literature 1) discloses a liquid circulation module integrally having a printhead and an ink circulation path.

In Literature 1, in moving the printhead to, for example, a maintenance position for maintenance, the weight of conveyance is large because the printhead is integral with the ink circulation path. As a result, larger driving force is needed to move the printhead, which may lead to higher cost due to, e.g., size increase of an actuator.

### SUMMARY OF THE INVENTION

A printing apparatus according to an aspect of the present disclosure has a circulation unit including a first liquid moving unit configured to supply liquid to a printhead and a second liquid moving unit configured to discharge the liquid circulated inside the printhead and not ejected from an ejection port to an outside of the printhead; a head unit including the printhead and a holding unit configured to hold the printhead; and a head moving unit configured to move the head unit in a first direction, and the circulation unit overlaps with a projection plane of the head unit and is not moved by the head moving unit.

Further features of the present invention will become apparent from the following description of exemplary embodiments with reference to the attached drawings.

### BRIEF DESCRIPTION OF THE DRAWINGS

FIG. 1 is a schematic diagram showing an example rough configuration of a printing apparatus;

FIG. 2 is a perspective view showing an example printhead;

FIGS. 3A and 3B are diagrams illustrating a liquid circulation path;

FIGS. 4A to 4C are diagrams schematically showing the arrangement of a head unit and a liquid circulation unit;

FIGS. 5A and 5B are diagrams schematically showing the arrangement of the head unit and the liquid circulation unit;

FIGS. 6A to 6C are diagrams schematically showing the arrangement of the head unit and the liquid circulation unit;

FIGS. 7A to 7C are diagrams schematically showing the arrangement of the head units and the liquid circulation units;

FIGS. 8A to 8C are diagrams schematically showing the arrangement of the head units and the liquid circulation units;

FIGS. 9A to 9C are diagrams schematically showing the arrangement of the head units and the liquid circulation units;

FIGS. 10A to 10C are diagrams schematically showing the arrangement of the head units and the liquid circulation units;

FIGS. 11A to 11C are diagrams schematically showing the arrangement of the head units and the liquid circulation units;

FIG. 12 is a diagram schematically showing the arrangement of the head unit and the liquid circulation unit;

FIG. 13 is a diagram illustrating the liquid circulation path; and

FIGS. 14A to 14C are diagrams schematically showing the arrangement of the head units and the liquid circulation units.

### DESCRIPTION OF THE EMBODIMENTS

Preferred embodiments of the present disclosure are described in detail below with reference to the drawings attached hereto. Note that the embodiments below are not intended to limit the matters in the present disclosure, and not all the combinations of the features described in the embodiments below are necessarily essential as the solutions provided by the present disclosure. Note that the same reference number is used to denote the same constituent.

### First Embodiment

### <Overall Configuration of the Printing Apparatus>

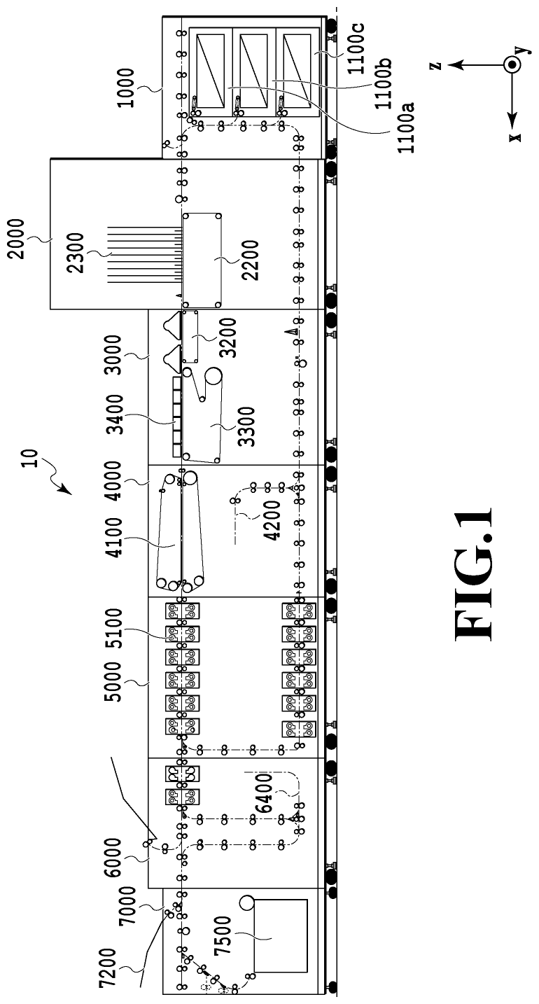

An overall configuration of a printing apparatus 10 of the present embodiment is described below with reference to the drawings. Note that in the drawings, arrows x and y represent horizontal directions that are orthogonal to each other, and an arrow z represents a vertical direction. An x-direction is a conveyance direction in which a sheet S as a printing medium is conveyed in the printing apparatus 10 as a whole, or is particularly a conveyance direction in which the sheet S is conveyed in a print unit 2300. Also, directions in FIG. 1 are defined as follows: an upper side of the apparatus as top, a direction from right to left is a longitudinal direction, and a direction from the near side on the paper plane to the far side on the paper plane, which is orthogonal to the sheet conveyance direction, is a sheet width direction, with the near side on the paper plane being an apparatus front side and the far side on the paper plane being an apparatus rear side.

FIG. 1 is a schematic diagram showing an example rough configuration of the printing apparatus 10. The printing apparatus 10 is a sheet printing apparatus that manufactures a printed object by forming an ink image on a sheet S using two types of liquid: reaction liquid and ink. The printing apparatus 10 of the present embodiment has a paper feed module 1000, a print module 2000, a drying module 3000, a fixation module 4000, a cooling module 5000, an inversion module 6000, and a paper discharge and stack module 7000. The sheet S in a cut paper shape supplied from the paper feed module 1000 is conveyed along a conveyance path, subjected to processes by the modules, and discharged to the paper discharge and stack module 7000.

In the paper feed module 1000, three storages 1100a to 1100c for housing sheets S are disposed. The storages 1100a to 1100c are each configured to be drawable to the apparatus front side (the near side on the paper plane). The sheets S are fed one at a time from each of the storages 1100a to 1100c by a separation belt and conveyance rollers and is conveyed to the print module 2000. Note that the present disclosure is not limited to having three storages 1100a to 1100c and may be configured having one or two storages or four or more storages.

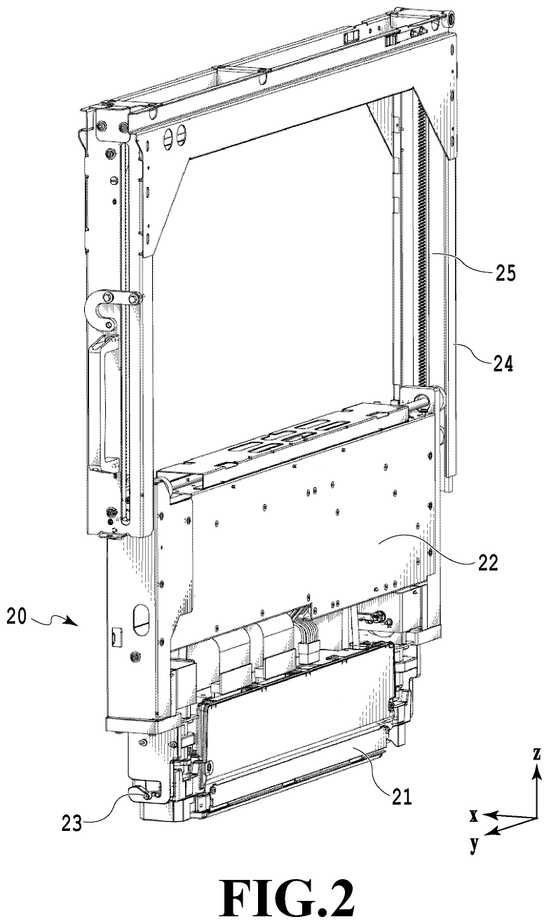

The print module 2000 has a pre-image-formation registration correction unit (not shown), a print belt unit 2200, and the print unit 2300. The sheet S conveyed from the paper feed module 1000 is corrected in the sheet's tilt and position by the pre-image-formation registration correction unit and is conveyed to the print belt unit 2200. The print unit 2300 is disposed at a position facing the print belt unit 2200 across the conveyance path of the sheet S. The print unit 2300 forms an image on the sheet S conveyed thereto by performing a print process from above on the sheet S using a printhead 21 (see FIG. 2). The sheet S is given clearance from the printhead 21 by being suctioned onto and conveyed by the print belt unit 2200. Also, a plurality of the printheads 21 are arranged side by side in the conveyance direction (the x-direction).

FIG. 2 is a perspective view of an example of the printhead 21. The print unit 2300 of the present embodiment has a plurality of printheads 21, and FIG. 2 shows one of the printheads 21. As shown in FIG. 2, the printhead 21 has a printhead support shaft 23. The printhead 21 is pivotally supported by a printhead holding unit 22, which is for holding the printhead 21 and raising and lowering the printhead 21 vertically, with the printhead support shaft 23 being supported by the printhead holding unit 22 from below. Using a drive mechanism provided thereinside (not shown), which is a head moving unit, the printhead holding unit 22 performs a raising/lowering operation vertically (the z-direction) along raising/lowering rails 25 provided inside a printhead raising/lowering frame 24. Hereinafter, the printhead 21 and the printhead holding unit 22 are together referred to as a head unit 20.

The position at which the head unit 20 is lowered is a print position where the printhead 21 performs printing. The position at which the head unit 20 is higher than the print position is a retracted position where the printhead 21 is retracted. Between the print position and the retracted position, there is a maintenance position where the printhead 21 receives maintenance. Although configured to be movable to the three positions in the present embodiment, the head unit 20 only has to be configured movable to two or more positions. For example, the retracted position and the maintenance position may be at the same position.

Referring back to FIG. 1, the print unit 2300 of the present embodiment has a total of five line-type printheads 21 corresponding to four colors, Y (yellow), M (magenta), C (cyan), and Bk (black), and reaction liquid. Note that the number of types of liquid and the number of printheads are not limited to five. Examples of an inkjet method that can be employed include a method using heat generation elements, a method using piezoelectric elements, a method using electrostatic elements, and a method using MEMS elements. An ink of each color is supplied to the corresponding printhead 21 from an ink tank through an ink tube (neither shown).

The sheet S printed by the print unit 2300 is conveyed by the print belt unit 2200. The printed image can be corrected based on detection of displacement and color density of the image formed on the sheet S by an inline scanner (not shown) disposed downstream of the print unit 2300 in the conveyance direction.

The drying module 3000 has a decoupling unit 3200, a drying belt unit 3300, and a hot air blowing unit 3400. The drying module 3000 is a unit that decreases a liquid component included in the ink applied to the sheet S by the print unit 2300 to enhance the fixation between the sheet S and the ink. The sheet S printed in the print unit 2300 of the print module 2000 is conveyed to the decoupling unit 3200 disposed in the drying module 3000. In the decoupling unit 3200, the sheet S can be conveyed due to wind pressure from above and friction against the belt, and the sheet S is weakly held onto the belt to prevent displacement of the sheet S on the print belt unit 2200 where an ink image is formed. The sheet S conveyed from the decoupling unit 3200 is suctioned onto and conveyed by the drying belt unit 3300 and at the same time, receives hot air from the hot air blowing unit 3400 disposed above the belt. The ink application surface of the sheet S is thereby dried. Note that as the drying method, the method using application of hot air may be combined with a method using application of electromagnetic waves (such as ultraviolet or infrared rays) to the surface of the sheet S or a heat conduction method bringing a heat generator into contact.

The fixation module 4000 has a fixation belt unit 4100. The fixation belt unit 4100 has an upper belt unit and a lower belt unit. The sheet S conveyed from the drying module 3000 is passed through between the heated upper and lower belt units, so that the ink can be fixed onto the sheet S.

The cooling module 5000 has a plurality of cooling units 5100. The cooling units 5100 cool the hot sheet S conveyed from the fixation module 4000 sheet S. The cooling units 5100 cool the sheet S by taking outside air into a cooling box using a fan to increase pressure inside the cooling box and blowing air discharged from nozzles formed in a conveyance guide against the sheet S. The cooling units 5100 are disposed at both sides of the conveyance path to be able to cool the sheet S from both sides. Also, the cooling module 5000 has a conveyance path switch unit thereinside to be able to switch the conveyance path of the sheet S depending on whether the sheet S is conveyed to the inversion module 6000 or conveyed to a double-side conveyance path used for double-sided printing. In double-sided printing, the sheet S is conveyed to a conveyance path below the cooling module 5000 and is further conveyed along the double-side conveyance path which travels through the fixation module 4000, the drying module 3000, the print module 2000, and the paper feed module 1000. Then, the sheet S is conveyed through the pre-image-formation registration correction unit, the print belt unit 2200, and the print unit 2300 in the print module 2000 again and printed by the printing unit. A double-side conveyance unit of the fixation module 4000 is provided with an inversion unit 1 (4200) for inverting the sheet S upside down.

The inversion module 6000 has an inversion unit 2 (6400) and can invert the sheet S conveyed thereto upside down using the inversion unit 2 (6400) and can freely change which surface of the sheet S faces upward upon discharge.

The paper discharge and stack module 7000 has a top tray 7200 and a stacker 7500 and aligns and stacks the sheet S conveyed from the inversion module 6000.

### <Description of the Head Unit and the Liquid Circulation Unit>

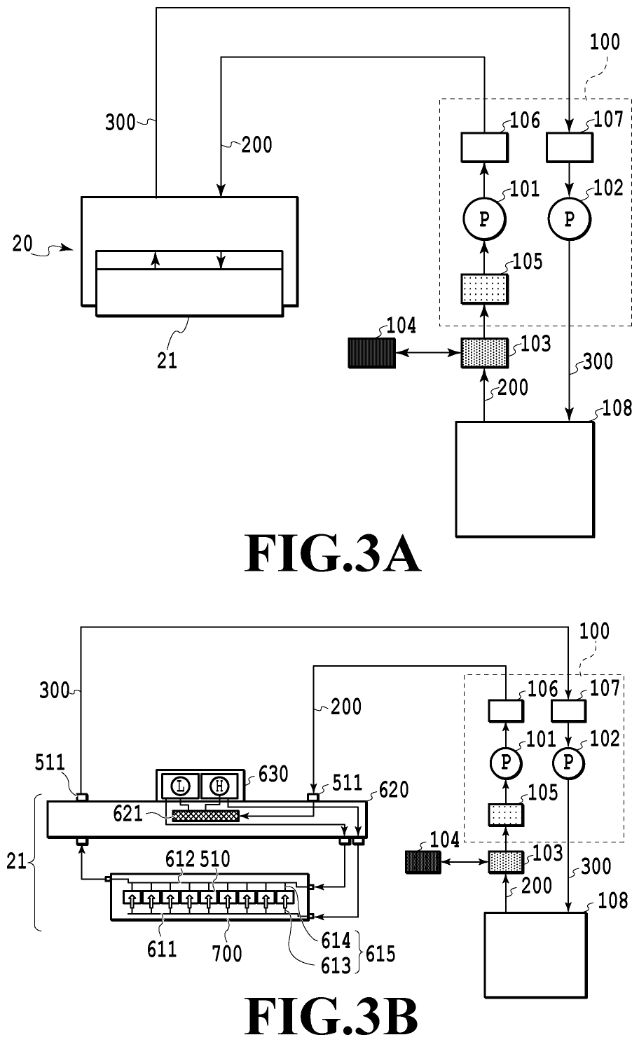

FIGS. 3A and 3B are diagrams illustrating a liquid circulation path including the head unit 20 and a liquid circulation unit 100. FIG. 3A is a schematic diagram showing a detailed configuration of the liquid circulation unit 100 for supplying ink to the printhead 21. Although the following description uses a printhead that ejects ink as an example, it is to be noted that the same applies to a printhead that ejects reaction liquid. The liquid circulation unit 100 of the present embodiment has a first pump 101 as a first liquid moving unit and a second pump 102 as a second liquid moving unit. The liquid circulation unit 100 also has a degassing module 105 as a degassing unit, a first damper 106 as a first pulsation damping unit, and a second damper 107 as a second pulsation damping unit. A buffer tank 108 is a storage unit where ink supplied from the ink tank (not shown) is stored. A supply flow channel 200 for supplying ink to the printhead 21 is connected to the buffer tank 108. Further, a collection flow channel 300 for collecting ink not ejected from ejection ports of the printhead 21 is connected to the buffer tank 108. The arrows in FIGS. 3A and 3B denote the direction in which the liquid flows (a circulation direction).

On the supply flow channel 200, a heat exchanger 103, the degassing module 105, the first pump 101, and the first damper 106 are disposed in this order from the buffer tank 108 side (a primary side).

The heat exchanger 103 adjusts the temperature of ink in cooperation with a temperature adjustment device 104, and heat exchange between ink and a constant-temperature medium is performed in the heat exchanger 103. The constant-temperature medium circulates between the heat exchanger 103 and the temperature adjustment device 104, and the temperature of the ink is adjusted by the temperature adjustment device 104.

The degassing module 105 is an ink degassing unit and is connected to a decompression pump (not shown) disposed outside the liquid circulation unit 100. The degassing module 105 has a porous hollow membrane film thereinside and is capable of decompressing the inside of the hollow fiber membrane by driving the decompression pump. In the event where ink flows into the degassing module 105 with the hollow fiber membrane being decompressed by the decompression pump, the dissolved gas (dissolved oxygen) is sucked into the hollow fiber membrane and is collected to the outside from the decompression pump. This allows the printhead 21 to be supplied with degassed ink.

The first pump 101 is an ink moving unit that supplies the printhead 21 with ink from the buffer tank 108 and is, for example, a diaphragm pump. The first damper 106 is a pulsation damping unit for ink supplied to the printhead 21 and is, for example, a damper having a diaphragm.

On the collection flow channel 300, the second damper 107 and the second pump 102 are disposed in this order from the printhead 21 side (the primary side).

The second damper 107 is a pulsation damping unit for ink discharged from the printhead 21 and is, for example, a damper having a diaphragm. The second pump 102 is an ink moving unit that collects ink from the printhead 21 into the buffer tank 108 and is, for example, a diaphragm pump.

Note that the configuration of the liquid circulation unit 100 is not limited to the configuration described in the present embodiment, and the configuration may include the heat exchanger 103. Further, the configuration may include, for example, a filter, an electromagnetic valve, a check valve, a pressure sensor, or a temperature sensor. Also, the constituents are connected either directly or via piping made of resin or metal.

FIG. 3B is a schematic diagram showing an ink circulation path in the printhead 21 in the present embodiment. By the first pump 101 in the liquid circulation unit 100, ink in the buffer tank 108 is supplied to a liquid supply unit 620 of the printhead 21 through a liquid connection unit 511. After that, ink is adjusted to have two different negative pressures (high pressure and low pressure) by a negative pressure control unit 630 connected to the liquid supply unit 620 and is separated into two flow channels: the high-pressure side and the low-pressure side. The ink in the printhead 21 circulates inside the printhead 21 due to the action of the second pump 102 in the liquid circulation unit 100 and is collected from the printhead 21 into the buffer tank 108 through a liquid connection unit 511. In this way, liquid that circulated in the printhead is discharged to the outside of the printhead by the second pump 102.

The second pump 102 in the liquid circulation unit 100 draws liquid through the liquid connection unit 511 of the printhead 21 and passes the liquid to the buffer tank 108. The second pump 102 is preferably a positive-displacement pump with a quantitative liquid sending capability. Although a diaphragm pump is used in the present embodiment, a mode is also possible in which, for example, a typical constant flow valve or relief value is disposed at the exit of the pump to achieve a constant flow rate. Operating the second pump 102 while the printhead 21 is driven causes ink to flow inside a common supply flow channel 611 and a common collection flow channel 612 at a predetermined flow rate. By flowing ink in this way, the printhead 21 is maintained in its temperature at optimal temperature during printing. It is preferable that the predetermined flow rate for the driving of the printhead 21 be set to a flow rate equal to or higher than a flow rate with which differences in temperature between printing element substrates 510 in the printhead 21 can be maintained within a certain range not affecting print quality. In a case where the flow rate is set too high, pressure loss in the flow channel in a liquid ejection unit 700 increases differences in negative pressure between the printing element substrates 510, which causes an image to have uneven density. For this reason, it is preferable that the flow rate be set considering differences in temperature and negative pressure between the printing element substrates 510.

The negative pressure control unit 630 is provided on a path between the first damper 106 in the liquid circulation unit 100 and the liquid ejection unit 700. The negative pressure control unit 630 operates to maintain pressure downstream of the negative pressure control unit 630 (i.e., on the liquid ejection unit 700 side) at a preset certain pressure even in a case where the flow rate of ink in the circulation system fluctuates due to, e.g., a difference in ejection amount per unit area. Two pressure adjustment mechanisms forming the negative pressure control unit 630, namely one for the high-pressure-side (H) and one for the low-pressure-side (L), may be any type of mechanisms as long as they can control pressure downstream of the negative pressure control unit 630 so that the pressure will not fluctuate beyond a certain range centering around a desired set pressure. As an example, a mechanism similar to what is called a “pressure-reducing regulator” can be employed. In the ink circulation flow channel in the present embodiment, pressure upstream of the negative pressure control unit 630 is increased by the first pump 101 via the liquid supply unit 620. This makes it possible to reduce the influence of head pressure on the printhead 21 due to the liquid level of ink housed in the buffer tank 108 and therefore to expand the flexibility of the layout of the buffer tank 108 in the printing apparatus.

The first pump 101 may be any pump as long as it has a lift pressure of a certain pressure or above within a range of an ink circulation flow rate used in driving the printhead 21, and a turbo pump, a positive-displacement pump, or the like can be used. A diaphragm pump is used in the present embodiment, but for example, a head tank disposed to have a certain head difference from the negative pressure control unit 630 can be employed instead.

As shown in FIG. 3B, the negative pressure control unit 630 includes two pressure adjustment mechanisms H, L for which different control pressures from each other are set. The pressure adjustment mechanism H with the higher pressure setting of the two pressure adjustment mechanisms (denoted as H in FIG. 3B) is connected to the common supply flow channel 611 in the liquid ejection unit 700. The pressure adjustment mechanism L with the lower pressure setting of the two pressure adjustment mechanisms (denoted as L in FIG. 3B) is connected to the common collection flow channel 612 in the liquid ejection unit 700 through the liquid supply unit 620. The liquid ejection unit 700 is provided with the common supply flow channel 611, the common collection flow channel 612, and individual flow channels 615 (individual supply flow channels 613 and individual collection flow channels 614) communicating with the printing element substrates 510. The pressure adjustment mechanism H is connected to the common supply flow channel 611, and the pressure adjustment mechanism L is connected to the common collection flow channel 612, so that differential pressure is generated between the two common flow channels. Because the individual flow channels 615 communicate with each of the common supply flow channel 611 and the common collection flow channel 612, the following flow (the arrows in FIG. 3B) is generated: part of the liquid flows from the common supply flow channel 611 to the common collection flow channel 612 via the internal flow channels in the printing element substrates 510. Note that the two pressure adjustment mechanisms H, L are each connected to a path from the liquid connection unit 511 via a filter 621.

In this way, a flow is generated the liquid ejection unit 700 such that the liquid flows passing through each of the common supply flow channel 611 and the common collection flow channel 612, with part of the liquid passing through the printing element substrates 510. This allows the heat generated in the printing element substrates 510 to be discharged to the outside of the printing element substrates 510 via the ink flowing through the common supply flow channel 611 and the common collection flow channel 612. Also, such a configuration makes it possible for ink to flow also through the ejection ports and pressure chambers that are not ejecting ink while the printhead 21 performs printing. This helps reduce the viscosity of ink thickened inside the ejection ports and thus prevent thickening of the ink. Also, thickened ink or a foreign matter in ink can be discharged to the common collection flow channel 612. Thus, the printhead 21 of the present embodiment can perform high quality printing at high speed.

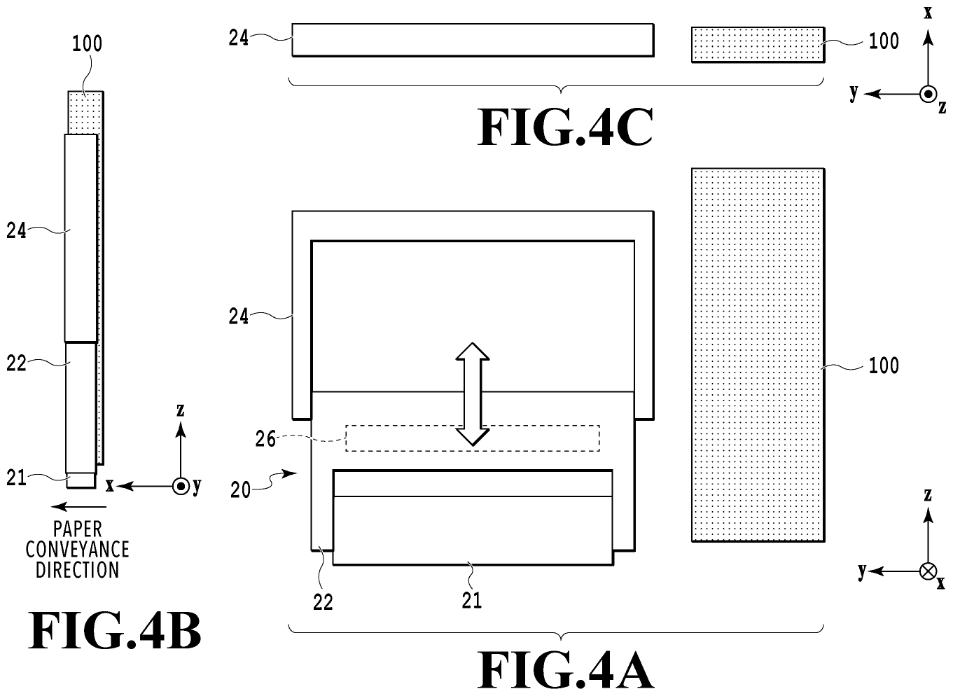

FIGS. 4A to 4C are diagrams schematically showing the arrangement of the head unit 20 at the print position and the liquid circulation unit 100. FIG. 4A is a view seen in the x-direction (the conveyance direction of the sheet S). FIG. 4B is a view seen in the y-direction (the ejection port array direction in which the ejection ports of the printhead 21 are arrayed). FIG. 4C is a view seen in the z-direction (from above the apparatus). Here, the liquid circulation unit 100 is schematically shown with its constituents depicted as a single unit. Also, the relation between the head unit 20 and the liquid circulation unit 100 in FIGS. 4A to 4C is roughly the same as the configuration shown in FIG. 3A. Specifically, it is assumed that the liquid circulation unit 100 has the supply flow channel 200 and the collection flow channel 300 arranged in the y-direction and the constituents on each flow channel arranged in the z-direction.

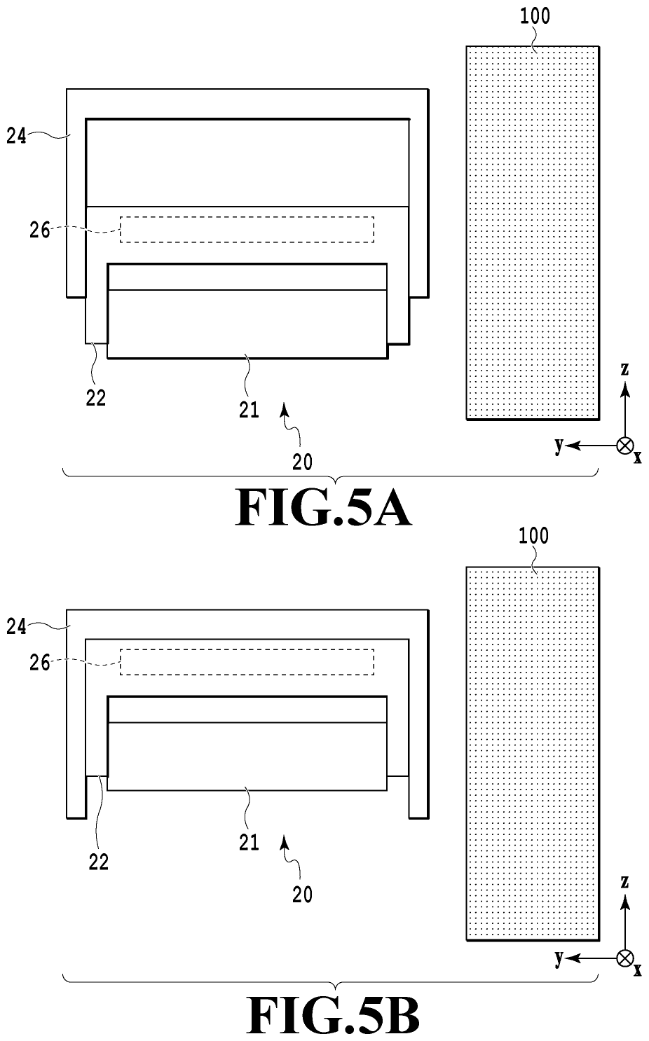

FIGS. 5A and 5B are diagrams schematically showing the arrangement of the head unit 20 and the liquid circulation unit 100. FIG. 5A is a diagram schematically showing the arrangement of the head unit 20 at the maintenance position and the liquid circulation unit 100. FIG. 5B is a diagram schematically showing the arrangement of the head unit 20 at the retracted position and the liquid circulation unit 100. At the retracted position shown in FIG. 5B, the printhead 21 is located higher than the print position shown in FIG. 4A by the printhead raising/lowering frame 24. At the maintenance position shown in FIG. 5A, the printhead 21 is located higher than the print position shown in FIG. 4A but lower than the retracted position shown in FIG. 5B by the printhead raising/lowering frame 24. As described earlier, the printhead 21 is moved in position by a driving mechanism 26 provided inside the printhead holding unit 22.

As shown in FIGS. 4A to 4C, the liquid circulation unit 100 of the present embodiment is installed overlapping with a projection plane of the head unit 20 in the x-direction, which is the short-side width direction of the head unit 20, so that the constituents allow the unit width to be small in the x-direction. Further, the liquid circulation unit 100 is disposed side by side with the head unit 20 in the y-direction. This consequently makes it possible for the printing apparatus 10 (the print module 2000) to have a smaller apparatus width in the x-direction. Note that the installation position of the liquid circulation unit 100 is not limited to this.

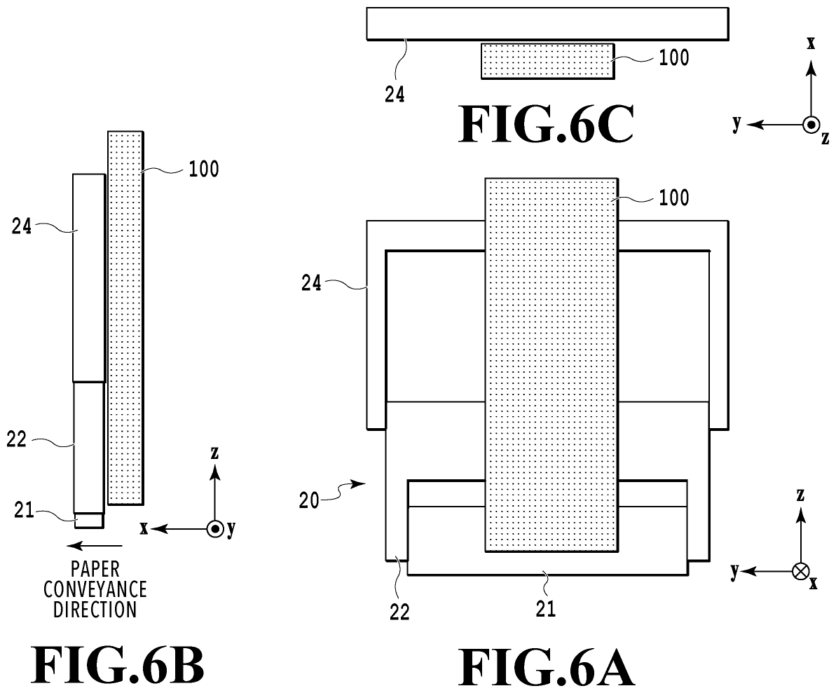

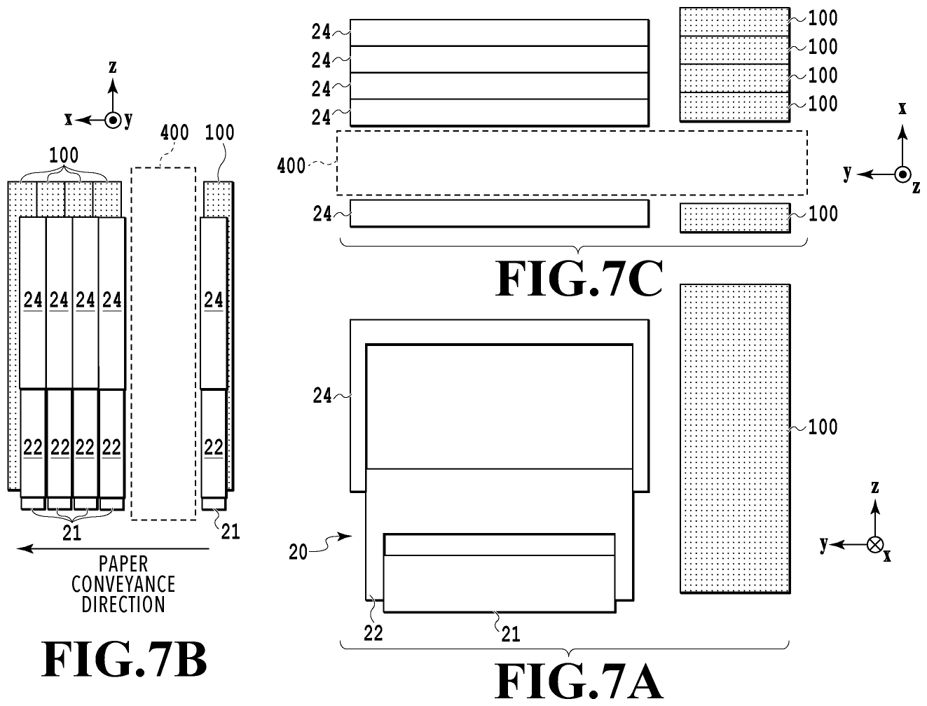

FIGS. 6A to 6C are diagrams schematically showing the arrangement of the head unit 20 and the liquid circulation unit 100. FIG. 6A is a view seen in the x-direction (the conveyance direction of the sheet S). FIG. 6B is a view seen in the y-direction (the ejection port array direction in which the ejection ports of the printhead 21 are arrayed). FIG. 6C is a view seen in the z-direction (from above the apparatus). Note that the viewpoints in FIGS. 7A to 7C to FIGS. 11A to 11C are the same as those in the example in FIGS. 6A to 6C. In the example described using FIGS. 4A to 4C, the liquid circulation unit 100 overlaps with a projection plane of the head unit 20 in the x-direction, which is the short-side width direction of the head unit 20. In the example shown in FIGS. 6A to 6C, the liquid circulation unit 100 is disposed overlapping with a projection plane of the head unit 20 in the y-direction, which is the long-side width direction of the head unit 20. Further, as shown in FIGS. 6A to 6C, the liquid circulation unit 100 is disposed side by side with the head unit 20 in the x-direction. The arrangement in FIGS. 6A to 6C allows the apparatus to have a smaller width in the y-direction.

Also, in the above configuration, the liquid circulation unit 100 does not move irrespective of whether the head unit moves to the retracted position, the maintenance position, or the print position. Thus, the driving mechanism 26 does not have to move the liquid circulation unit 100 and only has to move the head unit 20, which requires less driving force. Because lower actuator performance is consequently needed, size and cost can be reduced. For this reason, the flow channels from the first pump 101 and the second pump 102 to the head unit 20 can be shortened, which requires less pump performance and is consequently advantageous in terms of cost.

FIGS. 7A to 7C are diagrams schematically showing the arrangement of the head units 20 and the liquid circulation units 100. FIGS. 7A to 7C are diagrams showing an example where as many liquid circulation units 100 as the printheads 21 in the printing apparatus 10 in the present embodiment are disposed. Specifically, FIGS. 7A to 7C schematically show the arrangement of five head units 20, five printhead raising/lowering frames 24, and five liquid circulation units 100. In FIGS. 7A to 7C, an expansion space 400 is provided between the first and second head units 20 from the upstream side in the x-direction. The expansion space 400 is a space used for attaching an additional head unit 20.

The liquid circulation unit 100 is unitized with each corresponding head unit 20. In other words, the liquid circulation unit 100 is unitized for each type (color) of liquid ejected from the head unit 20. Thus, as shown in FIGS. 7A to 7C, the liquid circulation units 100 may be disposed side by side in the x-direction, as the head units 20 and the printhead raising/lowering frame 24 are. In the present embodiment, the liquid circulation units 100 corresponding to the respective head units 20 are each disposed to have the above-described positional relation with a projection plane of the corresponding head unit 20. As a result, the apparatus width can be reduced in the x-direction. Note that the installation positions of the plurality of liquid circulation units 100 are not limited to the example shown in FIGS. 7A to 7C.

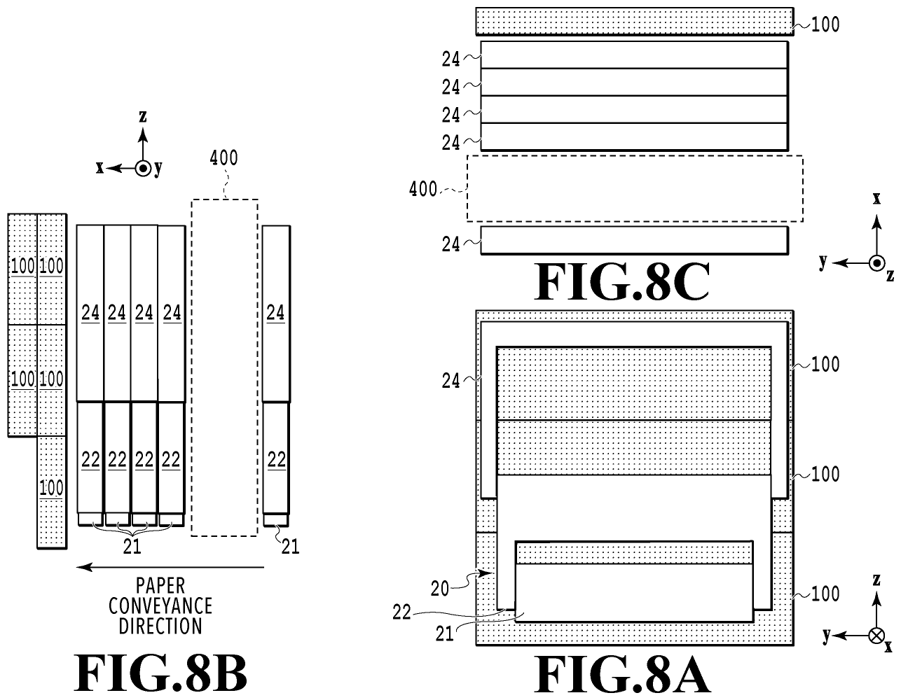

FIGS. 8A to 8C are diagrams schematically showing the arrangement of the head units 20 and the liquid circulation units 100. Unlike FIGS. 7A to 7C, FIGS. 8A to 8C are diagrams showing an example where the liquid circulation units 100 are disposed overlapping with projection planes of the head units 20 in the y-direction, which is the long-side width direction of the head units 20, and the five liquid circulation units 100 are grouped together and disposed side by side in the x-direction.

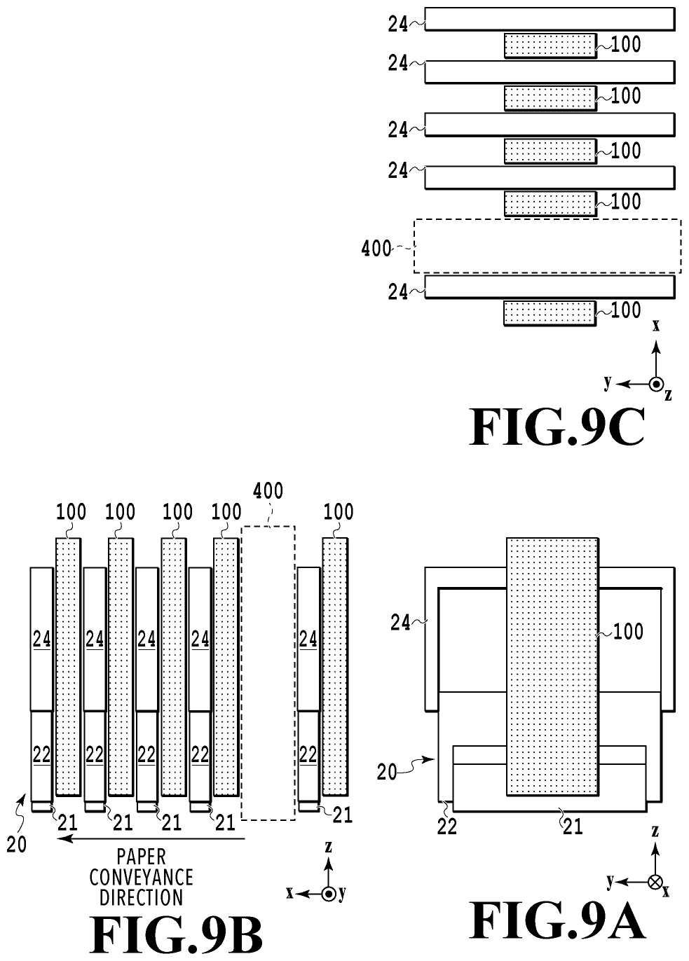

FIGS. 9A to 9C are diagrams schematically showing the arrangement of the head units 20 and the liquid circulation units 100. FIGS. 9A to 9C are diagrams showing an example where the liquid circulation units 100 are disposed overlapping with projection planes of the head units 20 in the y-direction, which is the long-side width direction of the head units 20, and pairs of the liquid circulation unit 100 and the head unit 20 for the respective types of liquid are arranged side by side in the x-direction.

In the examples shown in FIGS. 8A to 8C and FIGS. 9A to 9C, the apparatus width can be reduced in the y-direction. In any of the configurations shown in FIGS. 7A to 7C to FIGS. 9A to 9C, as described earlier, the liquid circulation units 100 are not moved by the driving mechanism 26, which is the head moving unit. Thus, the driving mechanism 26 does not have to move the liquid circulation units 100 and only has to move the head units 20, which requires less driving force. Because lower actuator performance is consequently needed, size and cost can be reduced. Further, in a case where the printing apparatus has the head units 20 for a plurality of colors, the liquid circulation units 100 can be disposed near the corresponding head units 20. For this reason, the flow channels from the first pump 101 and the second pump 102 to the head unit 20 can be shortened, which requires less pump performance and is consequently advantageous in terms of cost.

Further, the liquid circulation units 100 can have the same configuration, which enables the liquid circulation units 100 to be assembled using the same components and the same assembly procedure and therefore improves manufacturing efficiency as well. Also, the above arrangements allow the flow channels connecting the liquid circulation units 100 to the respective head units 20 to have the same length as each other and therefore improve ease of assembly. Moreover, a special color can be added only by additional installment of the head unit 20 and the liquid circulation unit 100 corresponding to the special color, without the arrangement of the existing head units 20 and the liquid circulation units 100 having to be changed. This offers good expandability. For example, in the present embodiment, an additional pair of the head unit 20 and the liquid circulation unit 100 can be added to the expansion space 400.

Although the driving mechanism 26 as a head moving unit is provided inside the printhead holding unit 22 in the present embodiment, it is to be noted that the present disclosure is not limited to this example. For example, the driving mechanism 26 as a head moving unit may be provided outside of the printhead holding unit 22, such as in the printhead raising/lowering frame 24. Although the head unit operates vertically (in the z-direction) in the present embodiment, for example, in a case where the conveyance direction is not horizontal, the head unit may operate in directions perpendicular to the sheet S. Further, although there are three operation positions for the head unit 20 in the examples described in the present embodiment, the present disclosure is not limited to this example. For example, the operation positions for the head unit 20 may be two positions which are the print position and the maintenance position, or the head unit 20 may be configured to move to more than three positions.

Also, although FIGS. 4A to 4C show an example where the liquid circulation unit 100 is disposed on the right side of the head unit 20 as seen from the upstream side of the conveyance direction of the sheet S (the x-direction), the liquid circulation unit 100 may be disposed on the left side thereof. Further, there may be a mixture of the liquid circulation unit 100 disposed on the right side of the head unit 20 and the liquid circulation unit 100 disposed on the left side of the head unit 20 as seen from the upstream side in the conveyance direction of the sheet S. Also, in the examples described in the present embodiment, the liquid circulation unit 100 is disposed overlapping with a projection plane of the head unit 20 in the x-direction, which is the short-side width direction of the head unit 20, at both of the print position and the retracted position of the head unit 20. However, the liquid circulation unit 100 may be configured to overlap with a projection plane of the head unit 20 at one of the positions.

Also, in the example shown in FIGS. 4A to 4C, the liquid circulation unit 100 overlaps with a projection plane of the head unit 20 in the x-direction. What it is meant by the liquid circulation unit 100 overlapping with a projection plane of the head unit 20 is that at least part of the liquid circulation unit 100 overlaps with at least part of a projection plane of the head unit 20. For example, the liquid circulation unit 100 may be disposed in such a manner as to completely encompass a projection plane of the head unit 20. Alternatively, the liquid circulation unit 100 may overlap with a small rim portion of a projection plane of the head unit 20. In either case, because the liquid circulation unit 100 is disposed at a position overlapping with a projection plane of the head unit 20, the apparatus can be reduced in size.

### Second Embodiment

Next, a second embodiment is described. The present embodiment is an example that differs from the first embodiment in the arrangement of the liquid circulation units 100. Specifically, in the present embodiment, the arrangement of the liquid circulation units 100 relative to the head units 20 and the printhead raising/lowering frames 24 is different. Other configurations are the same as those in the examples described in the first embodiment and are therefore not described here. In the examples described in the first embodiment, the liquid circulation unit 100 overlaps with a projection plane of the head unit 20 in a direction intersecting with the direction in which the printhead 21 is movable. In an example described in the present embodiment, the liquid circulation unit 100 overlaps with a projection plane of the head unit in the direction in which the printhead 21 is movable.

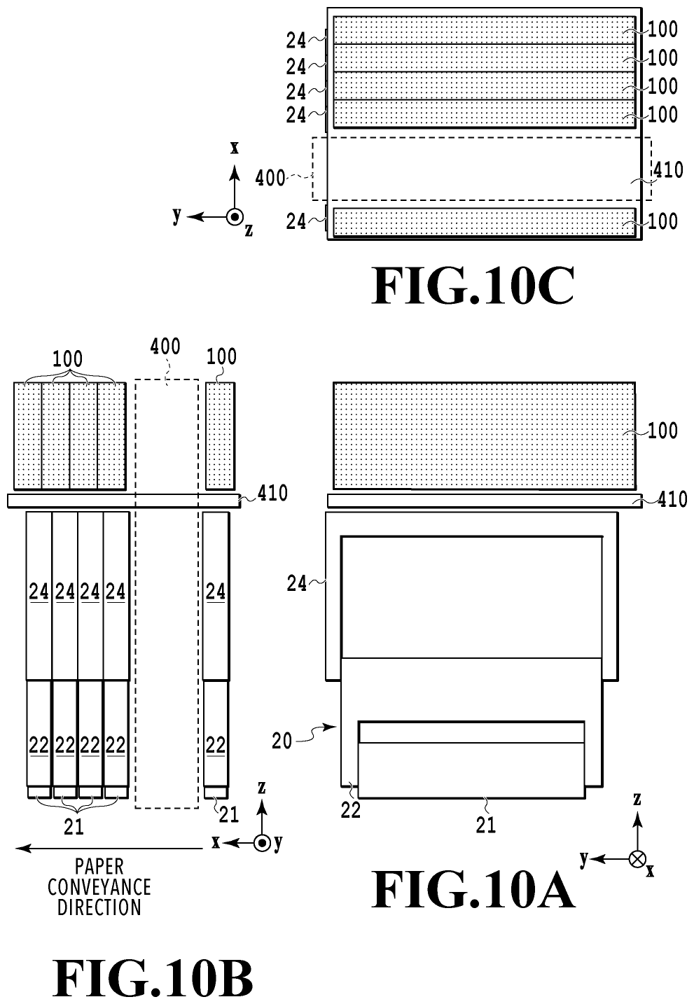

FIGS. 10A to 10C are diagrams schematically showing the arrangement of the head units 20 and the liquid circulation units 100. FIGS. 10A to 10C show an example where the liquid circulation units 100 overlap with projection planes of the head units 20 in the x-direction, which is the short-side width direction of the head unit 20, and are disposed above the head units 20. In other words, FIGS. 10A to 10C show an example where the liquid circulation units 100 overlap also with projection planes of the head units 20 in the z-direction, which is the ejection direction of the head units 20. Also, an ink receiving member 410 is disposed between the liquid circulation units 100 and the head units 20. Thus, should ink leak from the liquid circulation units 100, the ink receiving member 410 can help prevent members located below, such as the head units 20 and the sheet S, from being soiled or damaged. The same advantageous effects as those offered by the first embodiment can be expected from the present embodiment.

Although the liquid circulation units 100 are disposed above the head units 20 in the example shown in the present embodiment, it is to be noted that the liquid circulation units 100 may be disposed below the head units 20. In this case, the liquid circulation units 100 are disposed below the conveyance path of the sheet S. In either case, in the present embodiment, the liquid circulation units 100 each overlap with the corresponding head unit 20 at its projection planes in a plurality of directions.

### Third Embodiment

Next, a third embodiment is described. The present embodiment differs from the first embodiment in the head moving unit configured to move the head unit 20. Other configurations are the same as those in the examples described in the first embodiment and are therefore not described here.

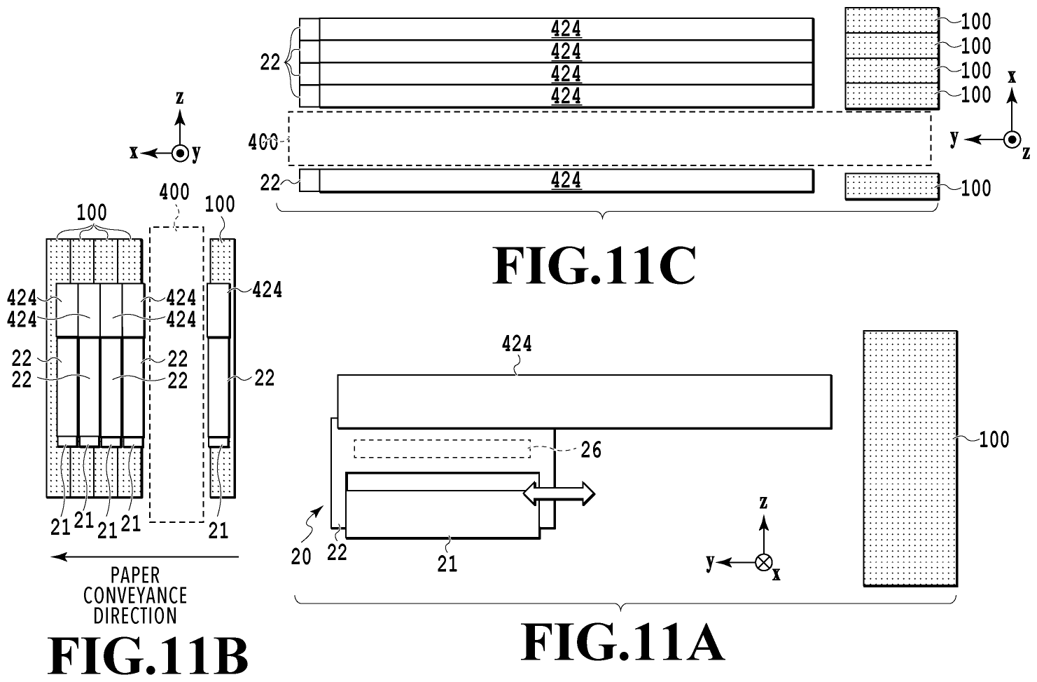

FIGS. 11A to 11C are diagrams schematically showing the arrangement of the head units 20 and the liquid circulation units 100. FIGS. 11A to 11C are diagrams schematically showing the arrangement of the head units 20 at the print position, printhead horizontal movement frames 424, and the liquid circulation units 100.

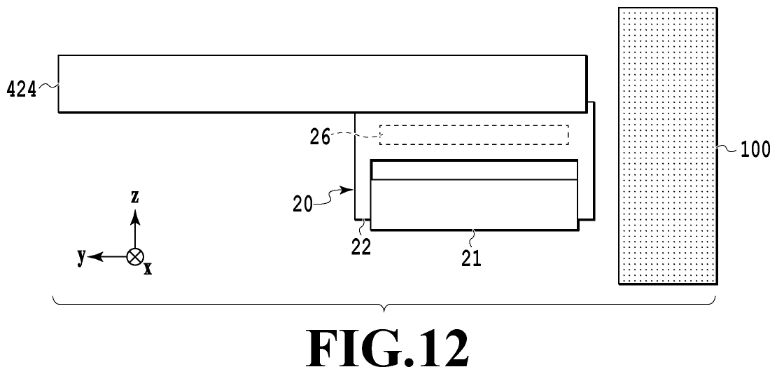

FIG. 12 is a diagram schematically showing the arrangement of the head unit 20 and the liquid circulation unit 100. FIG. 12 is a diagram schematically showing the arrangement of the head unit 20 at the retracted position, the printhead horizontal movement frame 424, and the liquid circulation unit 100. The head unit 20 is operated laterally along a horizontal movement rail provided inside the printhead horizontal movement frame 424 by the driving mechanism 26, which is a head moving unit provided inside the printhead holding unit 22. Also in a mode where the head unit moves in the direction as in the present embodiment, the same advantageous effects as those offered by the first embodiment can be expected.

Although the present embodiment describes an example where the head unit 20 moves in one direction, it is to be noted that the present disclosure is not limited to this example, and the head unit 20 may be configured to move in a plurality of directions.

### OTHER EMBODIMENTS

In the example described in the first embodiment using FIGS. 3A and 3B, the liquid circulation unit 100 is configured including the first pump 101, the second pump 102, the degassing module 105, the first damper 106, and the second damper 107. As described in the first embodiment, the liquid circulation unit 100 is not limited to the example shown in FIGS. 3A and 3B. For example, the liquid circulation unit 100 may include the heat exchanger 103. Also, the liquid circulation unit 100 may include the buffer tank 108.

Alternatively, the liquid circulation unit 100 may exclude the degassing module 105, the first damper 106, and the second damper 107 shown in FIGS. 3A and 3B. In other words, the liquid circulation unit 100 may be configured including the first pump 101 and the second pump 102. Also, as described earlier, a head tank may be used in place of the first pump 101. In other words, the head tank too may be a liquid moving unit that supplies liquid to the printhead 21.

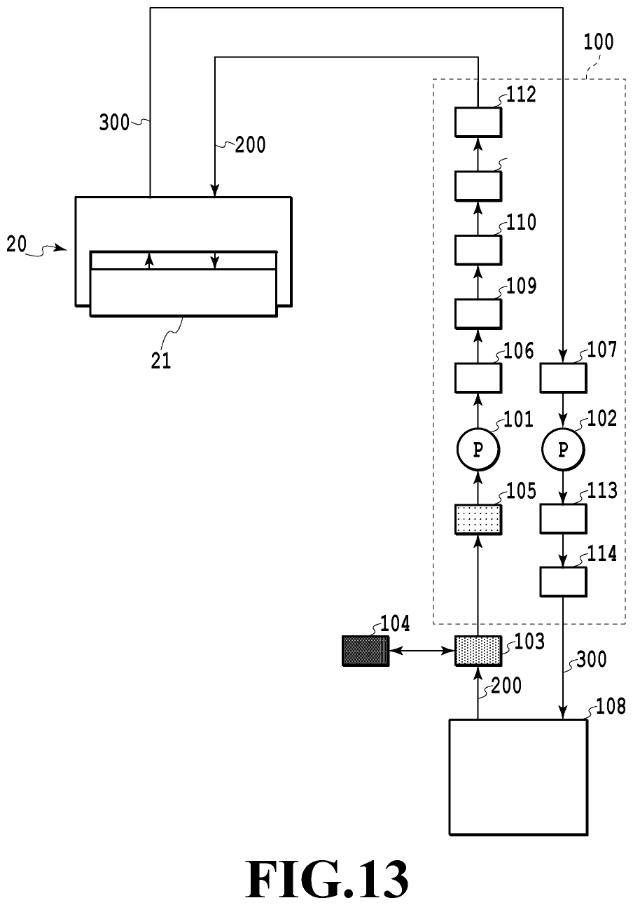

FIG. 13 is a diagram illustrating the liquid circulation path including the head unit 20 and the liquid circulation unit 100. In FIG. 13, in addition to the configuration shown in FIG. 3A, on the supply flow channel 200, a filter 109, a recovery valve 110, a temperature sensor 111, and a pressure sensor 112 are provided downstream of the first damper 106. Also, on the collection flow channel 300, a check valve 113 and a flow rate sensor 114 are provided downstream of the second pump 102. The filter 109 is used to remove foreign matters and the like. The recovery valve 110 is an electromagnetic valve used to, e.g., suck ink out of the printhead 21. The temperature sensor 111 measures the temperature of ink. The pressure sensor 112 measures pressure inside the flow channel. The check valve 113 is a check valve that prevents backward flow. The flow rate sensor 114 measures a flow rate in the flow channel. The liquid circulation unit 100 may have the configuration shown in FIG. 13 or may be without part of the configuration shown in FIG. 13.

Also, in the example described using FIGS. 7A to 7C, the five liquid circulation units 100 all overlap with projection planes of the corresponding head units 20. However, the present disclosure is not limited to this example. One of the liquid circulation units 100 may be disposed overlapping with a projection plane of the corresponding head unit 20. Better advantageous effects can be offered by the above embodiments in a case where all the liquid circulation units 100 overlap with the planes of projections of the corresponding head units 20 as shown in FIGS. 7A to 7C. Nevertheless, the advantageous effects of the above embodiments can be offered even in a case where one of the liquid circulation units 100 overlaps with a projection plane of the corresponding head unit 20.

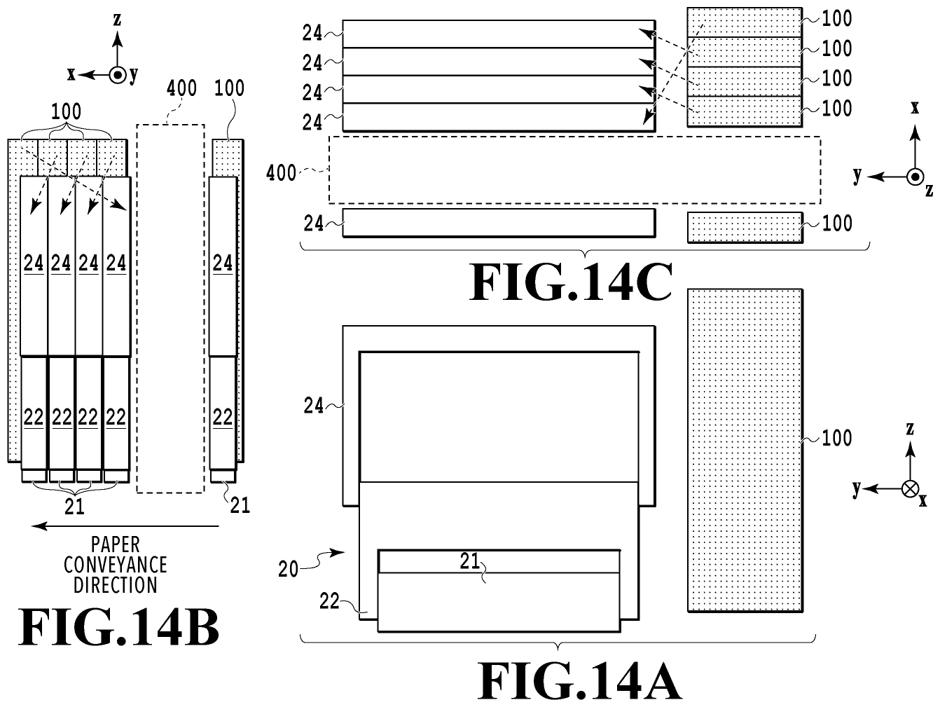

FIGS. 14A to 14C are diagrams schematically showing the arrangement of the head units 20 and the liquid circulation units 100, like FIGS. 7A to 7C. In the example shown in FIGS. 14A to 14C, some of the liquid circulation units 100 are each disposed overlapping with a projection plane of the head unit 20 for a different ink (i.e., the non-corresponding head unit 20). Specifically, as shown in FIG. 14B, the liquid circulation unit 100 located on the −x-direction side of the expansion space 400 overlaps with a projection plane of the corresponding head unit 20 in the x-direction. Meanwhile, the liquid circulation units 100 located on the +x-direction side of the expansion space 400 each overlap with a projection plane of the head unit 20 for a different ink in the x-direction. The example arrangement shown in FIGS. 7A to 7C enables the flow channels connecting the liquid circulation units 100 to the head units 20 to be the same and therefore improves ease of assembly. However, the example shown in FIGS. 14A to 14C too can achieve size reduction of the apparatus.

The present disclosure can provide a printing apparatus with which driving force for moving printheads can be decreased without increasing the width of the apparatus.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-100637, filed Jun. 20, 2023, which is hereby incorporated by reference wherein in its entirety.

What is claimed is:

1. A printing apparatus comprising:
a circulation unit including a first liquid moving unit configured to supply liquid to a printhead and a second liquid moving unit configured to discharge the liquid circulated inside the printhead and not ejected from an ejection port to an outside of the printhead;
a head unit including the printhead and a holding unit configured to hold the printhead; and
a head moving unit configured to move the head unit in a first direction, wherein
the circulation unit overlaps with a projection plane of the head unit and is not moved by the head moving unit.

2. The printing apparatus according to claim 1, wherein
at least part of the circulation unit overlaps with the projection plane of the head unit.

3. The printing apparatus according to claim 1, wherein
the circulation unit entirely overlaps with the projection plane of the head unit.

4. The printing apparatus according to claim 1, wherein
the printing apparatus includes a plurality of the head units and a plurality of the circulation units, and
each of the circulation units overlaps with a projection plane of a corresponding one of the head units.

5. The printing apparatus according to claim 1, wherein
the printing apparatus includes a plurality of the head units and a plurality of the circulation units, and
at least one of the circulation units overlaps with a projection plane of a corresponding one of the head units.

6. The printing apparatus according to claim 1, wherein
the circulation unit overlaps with the projection plane of the head unit in a direction intersecting with the first direction.

7. The printing apparatus according to claim 1, wherein
the circulation unit overlaps with the projection plane of the head unit in the first direction.

8. The printing apparatus according to claim 1, wherein
the circulation unit overlaps with a plurality of projection planes of the head unit.

9. The printing apparatus according to claim 1, wherein
the circulation unit further includes a degassing unit upstream of the first liquid moving unit in a circulation direction in which the liquid circulates, the degassing unit being configured to degas the liquid.

10. The printing apparatus according to claim 1, wherein
the circulation unit further includes
a first damper between the printhead and the first liquid moving unit and
a second damper between the printhead and the second liquid moving unit.

11. The printing apparatus according to claim 1, wherein
the head moving unit is configured to move the head unit in a direction perpendicular to a printing medium.

12. The printing apparatus according to claim 1, wherein
the head moving unit is configured to move the head unit in a direction horizontal to a printing medium.

13. The printing apparatus according to claim 1, wherein
the head moving unit is configured to move the head unit to a print position where printing is performed and a retracted position where printing is not performed.

14. The printing apparatus according to claim 13, wherein
the head moving unit is configured to move the head unit also to a maintenance position where maintenance is performed, the maintenance position being different from the print position and the retracted position.
